(19) United States
(12) Patent Application Publication
(10) Pub. No.: US 2014/0263822 A1
(43) Pub. Date: Sep. 18, 2014

(54) VERTICAL TAKE OFF AND LANDING AUTONOMOUS/SEMIAUTONOMOUS/REMOTE CONTROLLED AERIAL AGRICULTURAL SENSOR PLATFORM

(71) Applicant: Chester Charles Malveaux, Baton Rouge, LA (US)

(72) Inventor: Chester Charles Malveaux, Baton Rouge, LA (US)

(21) Appl. No.: 13/845,123

(22) Filed: Mar. 18, 2013

(51) Int. Cl. B64C 27/08; B64D 47/08; B64C 29/00

(52) U.S. Cl. CPC B64C 27/08; B64C 29/00; B64D 47/08
USPC 244/17.23

(57) ABSTRACT

The invention provides for a vertical takeoff and landing capable aerial vehicle with multiple rotors that is designed to carry agricultural sensors and telemetry allowing for real time control of agricultural equipment in accord with sensor data. The ability to carry a suite of agricultural sensors combined with multiple rotors will allow the craft to operate quickly in hovering and longitudinal flight over rows of farm fields and other vegetation and use an NDVI imager and other sensors to take data readings and real time imagery which will allow farmers and other personnel to determine vegetation type, need for chemical applications, plant fertilization, irrigation requirements, and other vegetation features including types of vegetation present. This will allow for precision agricultural, vegetation, and crop management and for farmers it will increase the efficiency of precision agriculture operations.

### CROSS-REFERENCE TO RELATED APPLICATIONS

Not Applicable

### STATEMENT REGARDING FEDERALLY SPONSORED RESEARCH FOR DEVELOPMENT

Not Applicable

### REFERENCE TO SEQUENCE LISTING

Not Applicable

### BACKGROUND OF THE INVENTION

Autonomous, semiautonomous, and remotely controlled aerial drones carrying cameras have been used for many years. These aerial vehicles can provide convenient aerial surveillance at a reduced cost and risk when compared to manned aircraft on similar missions, and can also eliminate some types of human error or natural frailty when flying under instrument only conditions or in hazardous environments. These types of aerial vehicles include vertical takeoff and landing capable aerial vehicles with multiple rotors holding independent motors driving the flight control rotors which provide thrust used for vertical and horizontal motion control while also providing fully proportional flight control on the roll, pitch, and yaw axes of the aerial vehicle.

### BRIEF SUMMARY OF THE INVENTION

The invention provides a vertical takeoff and landing capable aerial vehicle with incorporated agricultural sensors. Use of vertical takeoff and landing vehicles can provide real time imagery and sensor data from areas which cannot be readily accessed on foot or by vehicle. For example in agriculture where dense rows of crops are in place it is hard for agricultural specialists to access central crops on foot or by land vehicle without damaging some crops in the process. However, a vertical takeoff and landing aerial vehicle can carry a suite of sensors and imaging technology over the densest vegetation without doing any harm to crops. This aerial vehicle can then provide quick and accurate crop data. This crop data will help agricultural specialists and other interested parties determine crop type, what chemical applications are needed if any, the need for fertilizer and irrigation. A comprehensive understanding of crop growth and needed crop management techniques is possible with this invention.

Capable of rapid surveys of crops without the inherent risks and costs of conventional manned aircraft the embodiment of this invention as an unmanned aerial vehicle can quickly and safely provide real time crop data and also record crop data with its onboard personal digital assistant making this invention useful for making rapid adjustments and suitable for precision agriculture control regiments. With its onboard transmitters the device can also transmit real time crop and telemetry data so that agricultural equipment can be controlled in real time based upon its transmitted sensor inputs. It is risky to crops, and time consuming to carry sensors over crops by hand, or with land vehicles, but a vertical takeoff and landing capable aerial drone provides a safe and cost effective solution for carrying sensors for precision agriculture work.

It is, therefore, desirable to provide a vertical takeoff and landing capable aerial vehicle with incorporated agricultural sensors to farmers and agricultural specialists needing a crop data acquisition system.

### BRIEF DESCRIPTION OF THE SEVERAL VIEWS OF THE DRAWING

FIG. 1 is a top view of an embodiment of the aerial agricultural sensor platform showing the view looking down on the central section of the aerial vehicle and rotor support shafts in a tri rotor configuration. The camera is visible mounted front center. Next the lithium polymer battery is visible as a long thin rectangle immediately behind the camera. On the left rotor shaft the control system for the NDVI camera and agricultural sensors is shown as a rectangle mounted the left shaft. On the right rotor shaft a Personal Digital Assistant which receives and stores information from the NDVI camera and agricultural sensor suite is depicted as a rectangle mounted to the right shaft. Directly behind the battery a data and video 10 mile range radio transmitter is depicted by a small square. Just behind and to the left side of the radio transmitter a long range telemetry transmitter is depicted by a medium size square. Just behind and to the right side of the radio transmitter a long range remote control receiver and servo control unit is depicted by a medium size square. Directly behind the remote control receiver an autonomous flight control and gyro system is depicted by a medium sized square. On top of the flight control and gyro system a global positioning system is depicted by a small square. Three motor control units are depicted as partial rectangles protruding from the center section with two adjacent to either side of the battery and one adjacent to the flight control and gyro system. Bolt holes are also visible on the top upper deck plate as small circles, these bolt holes protrude thru the lower plate and allow the upper plate of the deck to be affixed to the bottom plate of the center section binding the aerial vehicle together and also holding the rotor shafts in place. 4 support legs are visible protruding from the sides of the aerial vehicle. Hexagons at the tip of each rotor shaft depict the electronic motor and rotor that provides flight thrust for this embodiment of the aerial agricultural sensor platform.

FIG. 2 is a front view of an embodiment of the aerial agricultural sensor platform showing the central body and rotor support shafts with agricultural sensor platform and NDVI cameral depicted by rectangles underneath the center section of the aerial vehicle. Support legs are also visible and extend underneath at a 20 degree angle to support the aerial vehicle during landing and takeoff. Two downward pointing triangles indicate the direction of the thrust vector from the three rotors of this embodiment of the aerial agricultural sensor platform.

FIG. 3 is an angled view of an embodiment of the aerial agricultural sensor platform showing the central section and rotor support shafts. Bolt holes are visible on the top upper deck plate as small circles, these bolt holes protrude thru the lower plate and allow the upper plate of the deck to be affixed to the bottom plate of the center section binding the aerial vehicle together. Three downward pointing triangles indicate the direction of the thrust vector from the three rotors of this embodiment of the aerial agricultural sensor platform. A curved arrow at the rear rotor shaft indicates that this thrust vector can be pivoted 45 degrees left of center and 45 degrees right of center in order to the control left and right yaw moment about the central access of the aerial vehicle, all other rotors are fixed in this embodiment of the invention. By varying the thrust of each independent motorized rotor a turn can be effectuated and forward or reverse motion can be achieved. This embodiment depicts a tri-copter version of the aerial agricultural sensor platform.

FIG. 4 is a right side view of an embodiment of the aerial agricultural sensor platform showing the central body and rotor support shafts with agricultural sensor platform and NDVI cameral depicted by rectangles underneath the center section of the aerial vehicle. Support legs are also visible and extend underneath at a 20 degree angle to support the aerial vehicle during landing and takeoff. Two downward pointing triangles indicate the direction of the thrust vector from the three rotors of this embodiment of the aerial agricultural sensor platform.

### DETAILED DESCRIPTION OF THE INVENTION

The present invention relates generally to vertical takeoff and landing capable aerial vehicles with multiple rotors. More particularly, the present invention relates to a modified multi-rotor aerial vehicle designed for carrying agricultural sensors for use in precision agricultural applications and for the study of vegetation by interested parties. The aerial vehicle includes a center section which holds agricultural and a suite of vegetation sensors which can include an NDVI camera as well as other sensors. A video camera which allows photography and first person video flight control by remote operators of the aerial vehicle is attached to the front of the aerial vehicle. Multiple shafts radiate out from the center section and hold multiple independent electric motor driven rotors. The automated flight control system interfaces with global positioning system and compass guidance and stabilizes the aerial vehicle for optimum stabilization of the aerial agricultural sensor platform affixed to the central area of the drone, allowing for autonomous, semiautonomous, and stabilized remote control flight of the aerial vehicle over farm land and other sites where vegetation is being analyzed. On board radio transmitters relay sensor and flight data back to a ground control station for processing, data storage, and flight control. The agricultural sensor sweet consists of sensors optimized for precision agriculture crop management, including nitrogen level detection, infrared, NDVI crop scanning, and other sensors allowing the precise application of agricultural chemicals, fertilizer, irrigation, and other implements of farming along with allowing for the real time control of agricultural and other machinery based upon sensor data collected by the aerial vehicle. As pictured the tri-copter configured embodiment of the invention is a best mode for carrying out the invention as it provides excellent flight control for placing the agricultural sensors and cameras over crops while also providing extended flight times due to its light weight.

What is claimed is:

1. A multi-rotor autonomous, semiautonomous and remotely piloted unmanned aerial vehicle capable of vertical takeoff and landing comprising: a center section consisting of two plates with an internal clamping system which bind body plates creating a rigid structural sandwich where the internal clamping system also holds rotor supporting frame shafts which extend out from in-between the plates in order to hold multiple rotors.

2. An aerial vehicle capable of vertical takeoff and landing comprised of a center section consisting of a central hub with an internal structure holding multiple frame shafts which extend out from the central hub and hold independent electric motor driven rotors at their tips.

3. An aerial vehicle of claim 1 wherein the multiple frame shafts then hold multiple rotors driven by independent electric motors placed at their tips.

4. An aerial vehicle of claim 1 wherein the multiple frame shafts also hold and support electrical conduits connecting to the center section which then convey operational current and control signals to the electric motors from a microcontroller and onboard self stabilizing and navigational aid guided flight control system, remote control, electronic motor controls and battery system mounted to the center section of the aerial vehicle.

5. An aerial vehicle of claim 2 wherein frame shafts contain electrical conduit which convey operational current and control inputs to the electric motors from autonomous, semiautonomous, and user controlled inputs from the center section vehicle control system utilizing fly by wire control and automated flight management along with gyro stabilization.

6. An aerial vehicle of claim 1 wherein an NDVI camera is affixed to the central structure allowing the unmanned aerial vehicle to take NDVI photographs of crops in order to calculate nitrogen content, crop type, other crop features, and the need for the addition of fertilizer, and or agricultural chemicals to crops to allow for precision distribution of agricultural resources in order to reduce pollution from farm runoff, increase cost effectiveness of farming activities, and increase farm efficiency.

7. An aerial vehicle of claim 2 wherein an NDVI camera is affixed to the central structure allowing the unmanned aerial vehicle to take NDVI photographs of crops in order to calculate nitrogen content, crop type, other crop features, and the need for the addition of fertilizer, and or agricultural chemicals to crops to allow for precision distribution of agricultural resources in order to reduce pollution from farm runoff, increase cost effectiveness of farming activities, and increase farm efficiency.

8. An aerial vehicle of claim 1 wherein a crop sensor suite is affixed to the central structure allowing the unmanned aerial vehicle to calculate nitrogen content, moisture content, and determine the need for the addition of fertilizer, agricultural chemicals, and or irrigation to crops to allow for precision distribution of agricultural resources in order to reduce pollution from farm runoff, increase cost effectiveness of farming activities, and increase farm efficiency. Crop sensor suite may consists of cameras both infrared and near infrared, chemical detectors, and other analysis equipment suitable for calculating crop type, pollution, moisture content, and other crop features relevant to agricultural analysis and control or monitoring of other vegetation.

9. An aerial vehicle of claim 2 wherein a crop sensor suite is affixed to the central structure allowing the unmanned aerial vehicle to calculate nitrogen content, moisture content, and determine the need for the addition of fertilizer, agricultural chemicals, and or irrigation to crops to allow for precision distribution of agricultural resources in order to reduce pollution from farm runoff, increase cost effectiveness of farming activities, and increase farm efficiency. Crop sensor suite may consists of cameras both infrared and near infrared, chemical detectors, and other analysis equipment suitable for calculating crop type, pollution, moisture content, and other crop features relevant to agricultural analysis and control or monitoring of other vegetation.

10. A vertical takeoff and landing capable aerial vehicle of claim 1 wherein the multiple shafts make up 3, 4, 6, 8, 10, or more rotor arm assemblies.

11. A vertical takeoff and landing capable aerial vehicle of claim 2 where in the multiple shafts make up 3, 4, 6, 8, 10, or more rotor arm assemblies.

12. An aerial vehicle of claim 1 wherein an onboard microprocessor and data storage device is carried onboard in order to record NDVI crop data and or crop sensor suite data for processing at completion of flight.

13. An aerial vehicle of claim 2 wherein an onboard microprocessor and data storage device is carried onboard in order to record NDVI crop data and or crop sensor suite data for processing at completion of flight.

14. A vertical takeoff and landing aerial vehicle of claim 1 wherein onboard telemetry routes flight instrumentation and GPS location data via radio modem to a remotely located central control facility or personal computer with ground control software so that real time flight control and tracking can be accomplished at the central ground control station.

15. A vertical takeoff and landing aerial vehicle of claim 2 wherein onboard telemetry routes flight instrumentation and GPS location data via radio modem to a remotely located central control facility or personal computer with ground control software so that real time flight control and tracking can be accomplished at the central ground control station.

16. A vertical takeoff and landing aerial vehicle of claim 1 wherein onboard telemetry routes NDVI camera data and or crop sensor suite data via radio modem to a remotely located central control facility so that real time crop monitoring and condition data can be monitored, recorded for future analysis, and or applied to the immediate control of agricultural equipment or other machinery.

17. A vertical takeoff and landing aerial vehicle of claim 2 wherein onboard telemetry routes NDVI camera data and or crop sensor suite data via radio modem to a remotely located central control facility so that real time crop monitoring and condition data can be monitored, recorded for future analysis, and or applied to the immediate control of agricultural equipment or other machinery.

18. A vertical takeoff and landing aerial vehicle of claim 1 wherein the automated flight control system interfaces with global positioning system and compass guidance and gyro stabilizes the aerial vehicle for optimum stabilization of the aerial agricultural sensor platform affixed to the central area of the drone, allowing for autonomous, semiautonomous, and stabilized remote control flight with or without altitude hold over farm land or vegetation.

19. A vertical takeoff and landing aerial vehicle of claim 2 wherein the automated flight control system interfaces with global positioning system and compass guidance and gyro stabilizes the aerial vehicle for optimum stabilization of the aerial agricultural sensor platform affixed to the central area of the drone, allowing for autonomous, semiautonomous, and stabilized remote control flight with or without altitude hold over farm land or vegetation.
